(19) United States
(12) Patent Application Publication
(10) Pub. No.: US 2007/0150337 A1
(43) Pub. Date: Jun. 28, 2007

(54) Trucking document delivery system and method

(75) Inventors: Russell C. Hawkins, Tampa, FL (US); Robert V. Helms, Tampa, FL (US)

Correspondence Address: AKERMAN SENTERFITT, P.O. BOX 3188, WEST PALM BEACH, FL, 33402-3188, US

(73) Assignee: Pegasus TransTech Corporation, Tampa, FL (US)

(21) Appl. No.: 11/315,999

(22) Filed: Dec. 22, 2005

(51) Int. Cl. G07B 15/00; G07B 15/02

(52) U.S. Cl. 705/13

(57) ABSTRACT

Aspects of the invention are related to a point of sale system located at a truck stop that integrates an image processing device, such as a scanner. The system can transmit transportation documents to at least one remote recipient. Such a system can streamline the billing process in the trucking industry.

### FIELD OF THE INVENTION

The invention relates in general to the trucking industry and, more particularly, to document delivery systems for the trucking industry.

### BACKGROUND OF THE INVENTION

Large truckload carriers rely upon hundreds and, in some cases, thousands of drivers to support the transportation of goods to various sites located throughout North America. A driver is typically assigned a shipping load and related shipping documents. Upon delivery of the shipping load, the driver must obtain the consignee's signature on the shipping document as evidence of the delivery. However, transportation companies often cannot bill the receiving party for the rendered transportation services until the signed shipping documents are received by the billing department of the transportation company. In order to avoid potential delays in billing and payment collection, transportation companies strive to receive the signed shipping documents from a driver as quickly as possible upon completion of delivery.

A number of approaches have been proposed to expedite the delivery of the signed shipping documents. For instance, some transportation companies provide a terminal where a driver can drop off the signed shipping documents. Such terminals can be provided at various locations throughout the country. Though the signed shipping documents are received by the transportation company, such a system has drawbacks. Inevitably, some of the terminals are located in remote geographic areas, making convenient or efficient access difficult. Moreover, few transportation companies even have the resources to operate and maintain an extensive network of terminals.

Another known document delivery system involves the use of scanning service centers at truck stop locations throughout the country. At such locations, a document delivery system includes a standard personal computer, monitor, keyboard, mouse, receipt printer and an automatic feed document scanner. The signed shipping documents are scanned into the document delivery system, and additional data can be inputted by the operator. The scanned documents and other data are transmitted by way of a public network to a central data center. The scanned documents and other data are stored on the central server and can be retrieved by the recipients whose address was entered or read during the scanning process. While beneficial, such a document delivery system can be costly because it requires installation, maintenance and service. Further, the system complicates the training of truck stop cashiers because it introduces a stand-alone system with different interfaces.

Still another known document delivery system provides scanning kiosks at truck stop locations. The kiosk integrates a standard personal computer, monitor, keyboard, mouse, receipt printer and automatic flatbed document scanner. The kiosk user can scan the signed shipping documents. The scanned documents and other data entered by the kiosk user are transmitted by a private network into a central data center. The scanned documents and other data are stored on a central server and can be retrieved by recipient whose address was determined by swiping a magnetic card on the kiosk. Like the scanning service center approach, the kiosk scanning system is costly for transportation companies because it must install, maintain and service the. system. Further, the scanning process can be time consuming because the kiosk user must position and scan each individual shipping document.

Moreover, the above systems fail to address the needs of other interested parties, such as brokers and third party freight providers, who must receive some subset of the scanned documents. For instance, the brokers can be representatives of the shipping customer who have secured the right from the freight provider to outsource the movement of the freight to any carrier or method agreed upon by the shipper. In such case, the broker would like to receive, at a minimum, the proof of delivery document for the freight from the driver as soon as possible. With the prior approaches, the driver would have to scan this document subset in a separate transaction. However, transportation companies do not want to force a driver to perform two or more transactions to achieve document delivery to each of the interested parties.

Thus, there is a need for a document delivery system that can facilitate the billing process for transportation services, while minimizing the concerns associated with prior document delivery systems.

### SUMMARY OF THE INVENTION

Aspects of the invention are directed to a transportation document delivery system. In one embodiment, the system includes a point of sale system located at a truck stop, which can be, for example, a truck stop, a travel center, a commercial vehicle fueling location, and/or a commercial vehicle service location. The point of sale system includes a point of sale device and an image processing device. The point of sale system can have an associated display device.

The point of sale device is operatively connected to receive one or more electronic document images from the image processing device. The electronic document image can be of a transportation document, such as a proof of delivery, a bill of lading, a receipt, a log sheet, a rate confirmation sheet and/or an employment document.

In one embodiment, the point of sale device can be one of a cash register and an electronic cash register. The image processing device can be a scanner or a digital camera. In one embodiment, the system includes a remote electronic device having an electronic image of a transportation document. Thus, the image processing device can be operatively connected to receive the electronic image of the transportation document from the remote electronic device.

The system can further include a first remote recipient. The point of sale system can transmit at least a portion of the electronic document images to the first remote recipient. The first remote recipient and the point of sale system can be operatively connected by, for example, a computer network. The system can further include a second remote recipient. In such case, the point of sale system can transmit at least a portion of the one or more electronic document images to the second remote recipient. The second remote recipient and the point of sale system can be operatively connected by a computer network. The at least a portion of the at least one electronic image received by the first recipient can be different from the at least a portion of the at least one electronic image received by the second recipient. For instance, in the case of a plurality of electronic document images, the first remote recipient can receive all of the electronic document images, while the second remote recipient can receive all of the electronic document images or a subset of the plurality of the electronic document images.

The system can further include a central control system in communication with the point of sale system by a distributed computer network. The system can include a first remote recipient. The central control system can transmit at least a portion of the at least one electronic document image to the first remote recipient. The first remote recipient and the central control system can be operatively corrected by a computer network. In one embodiment, there can be a second remote recipient. The central control system can transmit at least a portion of the at least one electronic document image to the second remote recipient. The second remote recipient and the central control system can be operatively connected by a computer network. The at least a portion of the at least one electronic document image received by the first recipient can be different from the at least a portion of the at least one electronic document image received by the second recipient.

In one embodiment, the system can include a biometric data scanner operatively connected to the point of sale system. The biometric data scanner can be, for example, a fingerprint scanner or an iris scanner.

A peripheral device can be operatively connected to the point of sale system. The peripheral device can be a Bluetooth transceiver, a radio frequency transceiver, an infrared transceiver, a USB port, and/or a digital media port. In one embodiment, the peripheral device can be a bar code scanner.

The point of sale system or the central control system can include at least one of bar code or character recognition software. Equipped with such software, the point of sale system or the central control system can extract data from the at least one electronic document image. The point of sale system or the central control system can be operatively connected to transmit the extracted data to a remote recipient, such as by a computer network. The point of sale system or the central control system can convert the extracted data into a standard interface protocol, such as ANSI EDI, XML and a CSV file. The point of sale system can be operatively connected to transmit the extracted data to a central control system, which can be by way of a computer network. The central control system can transmit the extracted data to a remote recipient. The remote recipient can be operatively connected to the central control system by a computer network.

Another transportation document delivery system according to aspects of the invention includes a point of sale system located at a truck stop. The point of sale system includes a point of sale device and a document scanner. The point of sale device is operatively connected to receive electronic images of transportation documents from the scanner. The system also includes a central control system in communication with the point of sale system by a distributed computer network. A remote recipient is operatively connected to receive at least a portion of the electronic images of transportation documents from the point of sale system or the central control system.

In another respect, aspects of the invention concern a method of delivering documents comprising. The method includes the steps of: providing a point of sale system at a truck stop, and importing at least one electronic document image into the point of sale system. The truck stop can be a truck stop, a travel center, a commercial vehicle fueling location, or a commercial vehicle service location. The electronic document image can be of a transportation document. The transportation document can be a proof of delivery, a bill of lading, a receipt, a logs sheet, a rate confirmation sheet, and/or an employment document.

The at least one electronic document image can be imported from a scanner operatively connected to the point of sale system. Alternatively, the at least one electronic document image can be imported from a digital camera.

In one embodiment, the method can further include the step of transmitting the at least one electronic document image to at least one recipient. The at least one recipient can be determined based on data acquired by the point of sale system; by reading information contained on a barcode on the electronic document image; by the biometric information of a truck driver; or by reading information on one of a magnetic card, a smart card, a loyalty card or an electronic identification. The importing step can be performed by an operator. In such case, the at least one recipient can be determined by the operator. The transmitting step can occur over a computer network. The transmitting step is performed by the point of sale system and/or by a central control system operatively connected to the point of sale system. The system can further include the step of providing a loyalty point upon the completion of the importing step and/or the transmitting step.

The method can further include the step of providing an acknowledgement upon the completion of at least one of the importing step and the transmitting step. The acknowledgement can be a paper receipt or an electronic acknowledgement. A unique identifier can be provided with the acknowledgement. The unique identifier can be a number and/or a code word.

The electronic acknowledgement can be delivered to a computer. Alternatively, the electronic acknowledgement can be delivered to one of a smart-card, loyalty card or a personal identification device enabled to receive input from either the point of sale system or from a central control system operatively connected to the point of sale system. The electronic acknowledgement can be delivered to an onboard/handheld tracking or messaging system, a portable communications device, a cellular phone, a smart-phone, a personal digital assistant device and/or a handheld computer device.

The method can further include the steps of transmitting at least a portion of the at least one electronic document image to a first recipient, and transmitting at least a portion of the at least one electronic document image is to a second recipient. In such case, at least one of these transmitting steps can be performed over a computer network. The at least one document image transmitted to the first recipient can be different, at least in part, from the at least one document image transmitted to the second recipient.

The method can include the step of extracting data from the at least one imported electronic document image. The extracting step can be performed by the point of sale system or by a central control system operatively connected to the point of sale system. The documents can be transmitted to at least one recipient based on the data extracted from the documents. The extracting step can be performed using automated data extraction. In one embodiment, the extracting step is performed using one of Optical Character Recognition (OCR), Intelligent Character Recognition (ICR), Optical Mark Recognition (OMR) and/or bar code reading. The extracted data can be converted into a standard interface protocol, such as ANSI EDI, XML and a CSV file. The converted extracted data can be transmitted to at least one remote recipient.

The method can further include the steps: of presenting the at least one electronic document image on a display, reviewing the presented image, and/or electronically adjusting the document image. The step of adjusting documents electronically can be performed by the use of at least one of a keyboard, a mouse or touch screen. Further, the method can include the steps of rejecting the image of the electronic document image on the display, and repeating the step of importing at least one electronic document image into the point of sale system.

In one embodiment, the method can also include the steps of inputting additional data, and associating the additional data with the electronic document image on the display. The inputting step can be performed by the use of at least one of a keyboard, a mouse or touch screen.

The status of the point of sale system can be locally or remotely monitored. In such case, the status can be captured and reported to an operator of the point of sale system or other authorized party.

### BRIEF DESCRIPTION OF THE DRAWINGS

FIG. 1 is block diagram of a document delivery system according to aspects of the invention.

FIG. 2 is block diagram illustrating some of the main components of a point of sale system for the document delivery system illustrated in FIG. 1.

### DETAILED DESCRIPTION OF THE INVENTION

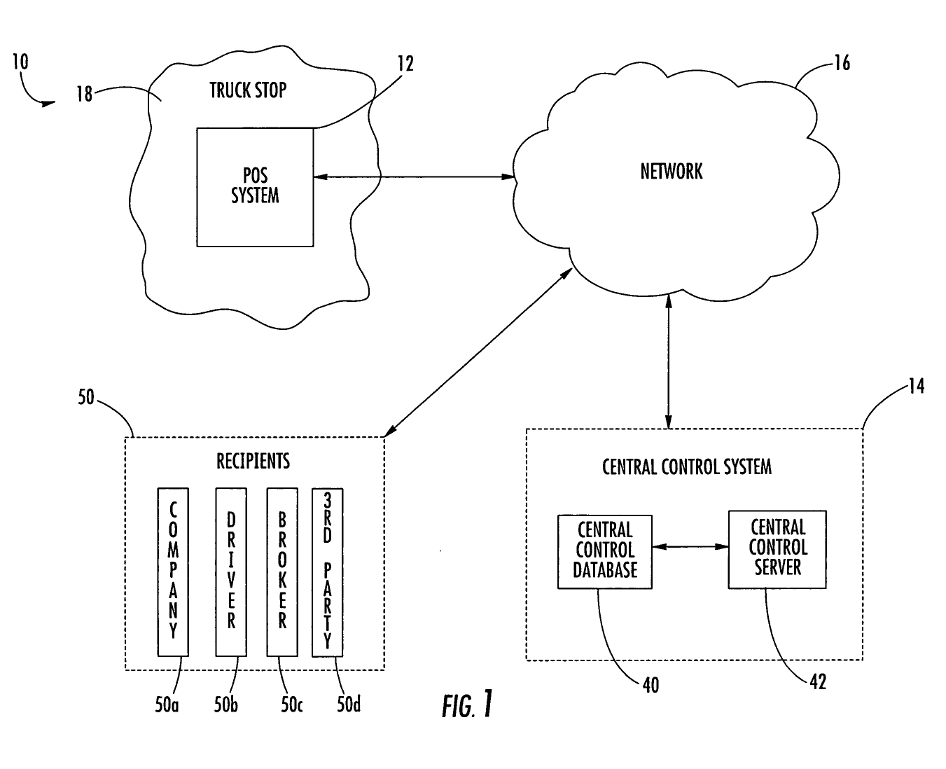

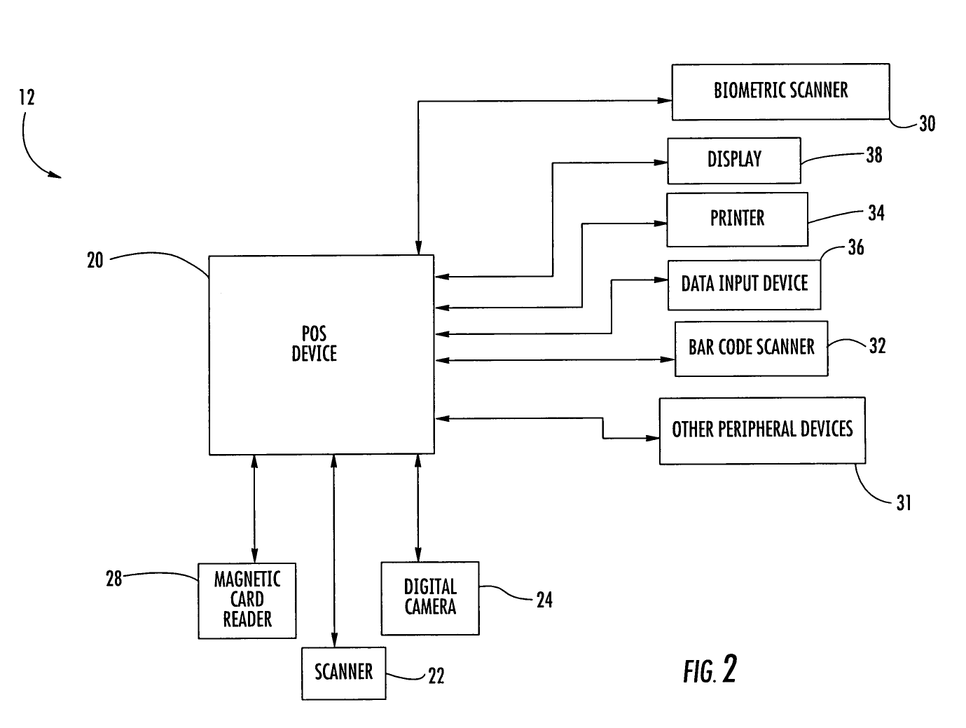

Embodiments of the invention are directed to a document delivery system associated with a point of sale (POS) system at a truck stop. Aspects of the invention will be explained in connection with one possible point of sale system, but the detailed description is intended only as exemplary. Embodiments of the invention are shown in FIGS. 1-2, but the present invention is not limited to the illustrated structure or application.

FIG. 1 is a block diagram of an exemplary embodiment of a document delivery system 10 according to aspects of the invention. The document delivery system 10 can include at least one POS system 12 in communication with a central control system 14 by a distributed computer network 16, which can be an internet connection. The central control system 14 and/or the one or more POS systems 12 can include system memory, including volatile and nonvolatile memory resources, for storing one or more application programs and an operating system. Preferably, the operating system is capable of image processing. It will be appreciated that the POS system 12 and/or the central control system 14 can be extended to encompass other types of data entry and data collection to support a variety of applications requiring the collection and communication of data between.

The POS system 12 can be located at a truck stop 18, which is intended to include truck stops, travel centers, commercial vehicle fueling locations, commercial vehicle service locations and other similar places. Examples of a POS system include Fujitsu's TeamPOS 2000, Epson's IM-320, and NCR's RealPOS 80, Trendar by Comdata, and other Windows-based systems. As shown in FIG. 2, the POS system 12 can include a POS device 20. Typically, the POS device 20 can be operated by an employee at the truck stop 18. However, in some instances, the POS device 20 can be a self-service system operated by the driver.

According to aspects of the invention, the POS device 20 can be operatively connected to an image processing device. The image processing device can be, for example, a scanner 22, a digital camera 24 or other device that can create document images for collection and subsequent transmission by the POS device 20. Alternatively or in addition, the image processing device can receive data, including image-type data, from the user. For example, the image processing device can be a magnetic card reader 28 for accepting encoded information contained on a magnetic card or “smart” card. In one embodiment, the image processing device can be operated by a truck stop employee, such as a cashier. Alternatively, the image processing device and/or other associated peripheral devices can be operated as a self-service system such that an authorized user, such as a driver, can perform processes independently of the cashier or other truck stop employee operating the point of sale system.

The POS device 20 and the image processing device can be operatively connected by various communication interfaces, including, for example, by a serial port, a parallel port, a game port, a universal serial bus (USB), a small computer system interface (SCSI), a Firewire, etc. It will be understood that other types of communication ports or interfaces can be used to provide a connection between the POS device 20 and the image processing device. Moreover, the communication link supported by such communication interfaces can be implemented by wired or wireless communication links, such as RF, infrared, and cabled links.

Upon completion of a delivery and obtaining the necessary signatures, a driver can proceed to a truck stop. The driver can present the transportation documents to a POS system 12 located at a truck stop 18 in accordance with aspects of the invention. Examples of transportation related documents include proof of delivery, bill of lading, receipts, log sheets or other papers, documents converted to an image, and/or biometric data of the driver. Electronic images of the transportation documents can be generated by the scanner 22 or otherwise imported into the POS device 20.

In addition to the image processing device, the POS device 20 can be operatively connected to one or more peripheral devices in any of the manners discussed above. In one embodiment, the POS device 20 can be operatively connected to a biometric data scanner 30, such as a fingerprint scanner or an iris scanner. The biometric data scanner 30 can collect the biometric data of the driver being serviced by the POS operator. Such information can be used as a security mechanism and to confirm that a particular driver is in a particular location.

Other examples of peripheral devices that can be operatively connected to the POS device 20 include a Bluetooth transceiver, a radio frequency transceiver, an infrared transceiver, a USB port, a digital media port. Further, the peripheral device can be a bar code scanner 32. The bar code scanner 32 can support the reading of bar code images. For example, a hand-held bar code scanner can be used to scan bar code images on transportation documentation. Operation of the bar code scanner 32 can be further supplemented by the use of a radio frequency (RF) tag reader or scanner to obtain RF tag information.

The POS system 12 can include a printer 34, a data input device 36 and/or a display device 38. The printer 34 can be any suitable printer. The data input device 36 can be a keyboard or a mouse. The data input device 36 can also be integrated with the display device 38. For example, the display device 38 can be a monitor that can support touch-screen operations to enable the user to enter information into the POS device 20 by touching certain areas of the display screen of the display device 38 corresponding to a keypad, buttons or controls.

The POS device 20 can communicate with the display device 38 to present document images of created or received by the image processing device to the POS operator and/or the driver to perform quality review and acceptance of the documents. These presented images can be reviewed to determine whether the scanned document is legible, properly oriented, or otherwise successful. The POS system 12 can allow an operator can supplement entry of data for an individual document or a group of documents. In one embodiment, the POS system 12 can provide the control necessary for the POS operator to type, select or verify data associated with one or a group of documents. Ideally, the POS device 20 is adapted to have the control necessary to adjust documents electronically, such as by keyboard, mouse and/or touch screen. Preferably, the POS device 20 is adapted to allow the POS operator to manipulate the text and other portions of the electronic document images.

In order to remotely monitor the POS system 12 including its associated peripherals, it is beneficial to accumulate status and statistics at the POS system 12 and then transmit such information to the central control system 14. The information would be recorded in a database 40 associated with the central control system 14. The central control system 14 can include software to read the data to monitor for specific conditions, trends, or non-responsive conditions. A user interface can be provided at the central control system 14 to allow administrators to visually determine the status of all POS systems reporting as part of the network, the document import and/or processing application running on the POS system 12, the status of the POS system 12, the POS device 20, any peripheral devices 31, the printer 34 or other POS components including any of those referred to above. The status can be reported to the POS operator or to a central server 42 for data collection, monitoring or reporting.

The POS system 12 can be connected to a central control system 14 or a local server connected or otherwise associated with the central control system 14. The communications link between the POS system 12 and the central control system 14 can be bi-directional. The data collection operations and communications conducted via the distributed computer network 16 can be controlled by the POS system 12. The POS system 12 can create and maintains a log or record of data collection and communication operations attempted by the POS system 12. Records can be maintained by the POS system 12 to document both successful and unsuccessful data collection tasks and data communication tasks. The POS system 12 can transmit this log information to the central control system 14, thereby creating an archival record of such operations and delivering present status data for review at the central control system 14 site.

The POS system 12 can return an acknowledgement of the transaction to the driver or the transportation company. The acknowledgement can be provided at any suitable point, such as after the document images have been received by the POS system and/or after delivery to one or more of the remote recipients. The acknowledgement can be provided in various forms and returned in any of a number of ways. For instance, an acknowledgement can be provided in the form of a paper receipt generated by the printer 34 of the POS system 12. Alternatively, an acknowledgement of the transaction can be an electronic receipt returned by the POS system 12 to various devices including but not limited to the following: a personal computer, laptop, an onboard/handheld tracking or messaging system, a cellular phone, a smart phone, a personal digital assistant (PDA) device or similar handheld computing device. These devices can belong to the driver, the transportation company or other party. Further, the POS system 12 can return the acknowledgement of the transaction by way of a smart card, loyalty card or other personal identification device able to receive input from the POS system 12. In any of the above cases, the acknowledgement can contain a unique number or code words. These numbers or code words can be used by the recipient or end user, to see the status of the transmission, view the electronic images of the documents, allow the transmission of the electronic images of the documents to other recipients or modify data associated with the electronic document images.

The electronic images of the documents and other inputted data can be transmitted to one or more recipients 50. The transportation company 50a can receive all of the electronic document images. However, other recipients, such as the driver 50b, a broker 50c or a third party 50d, may only need a subset of the electronic document images or a portion of the data contained on one or more of the electronic document images. To that end, data can be extracted from the electronic images of a document by any suitable technique such as through the use of automated tools including character recognition tools, manual labor or a combination thereof. The central control system 14 and/or the POS device 20 can include character recognition software and tools, including, for example, Optical Character Recognition (OCR), Intelligent Character Recognition (ICR) and/or Optical Mark Recognition (OMR).

The recipients of the electronic document images, a subset thereof, other inputted data and/or extracted data from the documents can be determined in any of a number of ways. For example, the recipients can be based on data received, known to or acquired by the POS system 12 and/or the central control system 14. For example, a primary recipient and/or other recipients can have a profile stored in a database 44 associated with the POS system 12 and/or a database 40 associated with the central control system 14. The profile can be used to customize document import application by modifying standard operation of one or more of the following: the user interface of the document import application; data elements allowed or required; the value of a data element allowed or required; and additional routing of documents allowed or required.

In one embodiment, the electronic documents images can be transmitted to one or more recipients based on information extracted from the electronic documents images by the POS system 12, such as by using automated or manual data extraction methods. Alternatively, the electronic documents images can be transmitted to one or more recipients based on information extracted from the electronic documents images by the central control system 14, such as by using automated or manual data extraction methods. The central control system 14 and/or the POS system 20 can determine which particular documents need to be routed to other recipients based on the data content of the electronic documents images or data received from the data content of the documents such as cross-referencing the data in a database 40. Further, the recipients can be determined by the POS operator by manually entering such information.

In one embodiment, a recipient of a document can be determined by reading information contained on a barcode that is present one or more of the electronic documents images. Alternatively, the barcode can be scanned on the original paper document. In another embodiment, a recipient of documents can be determined by reading a magnetic card, smart card, or other electronic identification presented by the driver. In still anther embodiment, a recipient can be determined by through a loyalty identification program associated with the driver or the recipients. In addition, recipients can be identified by data received from a biometric scan of the driver.

Once the recipients have been identified, the relevant documents or data can be transmitted. Before transmission to the remote recipients, the extracted data can be converted into a standard interface protocol. Examples of a standard interface protocol include ANSI EDI, XML, a comma separated value (CSV) file or any of a number of standard file formats suitable for integration into disparate computing systems.

The costs associated with conducting transactions using the document delivery system according to aspects of the invention can be charged to various entities. For instance, the truck stop 18 can charge the driver and/or the transportation company for use of one or more aspects of the POS system 12. In some cases, the truck stop 18 may not charge the driver and/or the transportation company. Instead, the truck stop 18 can be compensated by at least one of the recipients of the documents or by a third party service provider responsible for invoicing the recipients and compensating the truck stop 18.

To encourage future use of the same truck stop or a related or affiliated truck stop, each transaction can be counted toward a loyalty program. The loyalty program can offer certain rewards for repeated use. For instance, after a certain number of transactions using the POS system 12, the driver can receive a free transaction or a credit toward other merchandise at the truck stop 18.

It will be appreciated that the document delivery system 10 according to aspects of the invention can provide significant advantages over prior document delivery systems. The system allows a plurality of recipients to receive a relevant set of transportation documents or extracted data therefrom as a result of a single transaction by a driver, thereby allowing the recipients to expedite their ability to utilize data and reducing the costs of data extraction.

The cost of deployment of the document delivery system 10 according to aspects of the invention is expected to be less than other known systems. Known document delivery system involve the deployment of equipment (CPU, keyboard, mouse, monitor, receipt printer, LAN connectivity, etc.) that is duplicative to equipment already at the truck stop 18. In contrast, the deployment of document delivery system 10 according to aspects of the invention can be used in connection with a currently installed POS system. In some cases, the existing POS system may have to be replaced. But, in either case, the only additional hardware is an image processing device and a communication link such as a scanner cable.

Further, because prior document delivery systems were entire standalone systems, the truck stop 18 was responsible for maintaining a wide range of equipment including a CPU, keyboard, mouse, monitor, receipt printer, LAN connectivity, etc. In contrast, the only additional hardware that the POS-based document delivery system according to aspects of the invention that would require maintenance would be the image processing device and its associated cable.

Further, the POS document delivery system 10 according to aspects of the invention is well suited for integration into a truck stop. In a typical retail environment, every square foot of counter space is measured against the revenue it produces. The counter space of the fuel desk at a truck stop is no exception. These counters already offer a multitude of services such as scales, fuel speakers, fuels receipt prints, money wiring, facsimile, coping, etc. Due to the limited space, it is difficult for new services to be included. However, as noted above, the document delivery system would only introduce an image processing device and connection to an existing POS device. This relatively minimal space claim would certainly be more amenable to inclusion at a truck stop counter than an entirely new, standalone system.

Moreover, the turnover rate of employees in a retail environment, such as a truck stop, is relatively high. Because prior document delivery systems were separate from the other operator interfaces, it increased the number of interfaces and services on which a new employee had to be trained, thereby increasing the complexity of the training process for new employees more complex. However, by integrating the document delivery system according to aspects of the invention into a POS device, an existing user interface is being used, thereby enabling a new cashier to more quickly adapt to the service.

In view of the foregoing, it will be appreciated that the document delivery system according to aspects of the invention can satisfy a need within the truck stop retail industry for a lower cost, lower training document delivery system that can have similar functionality to the existing service center. The present invention can enhance the service center concept of document delivery of transportation documents to the transportation companies as well as other interested parties for expedited billing, bookkeeping and payroll.

The foregoing description is provided in the context of one possible point of sale system according to aspects of the invention. It will of course be understood that the invention is not limited to the specific details described herein, which are given by way of example only, and that various modifications and alterations are possible within the scope of the invention as defined in the following claims.

What is claimed is:

1. A transportation document delivery system comprising:
a point of sale system located at a truck stop, the point of sale system including a point of sale device and an image processing device, the point of sale device operatively connected to receive at least one electronic document image from the image processing device.

2. The system of claim 1 wherein the truck stop is one of: a truck stop, a travel center, a commercial vehicle fueling location, and a commercial vehicle service location.

3. The system of claim 1 wherein the at least one electronic document image is of a transportation document.

4. The system of claim 3 wherein the transportation document is at least one selected from the group of: a proof of delivery, a bill of lading, a receipt, a log sheet, a rate confirmation sheet or an employment document.

5. The system of claim 1 wherein the point of sale device is one of a cash register and an electronic cash register.

6. The system of claim 1 wherein the image processing device is a scanner.

7. The system of claim 1 wherein the image processing device is a digital camera.

8. The system of claim 1 further including a remote electronic device having an electronic image of a transportation document, wherein the image processing device is operatively connected to receive the electronic image of the transportation document from the remote electronic device.

9. The system of claim 1 further including a first remote recipient, wherein the point of sale system transmits at least a portion of the at least one electronic document image to the first remote recipient.

10. The system of claim 9 wherein the first remote recipient and the point of sale system are operatively connected by a computer network.

11. The system of claim 9 further including a second remote recipient, wherein the point of sale system transmits at least a portion of the at least one electronic document image to the second remote recipient.

12. The system of claim 11 wherein the second remote recipient and the point of sale system are operatively connected by a computer network.

13. The system of claim 11 wherein the at least a portion of the at least one electronic image received by the first recipient is different from the at least a portion of the at least one electronic image received by the second recipient.

14. The system of claim 1 further including a central control system in communication with the point of sale system by a distributed computer network.

15. The system of claim 14 further including a first remote recipient, wherein the central control system transmits at least a portion of the at least one electronic document image to the first remote recipient.

16. The system of claim 15 wherein the first remote recipient and the central control system are operatively connected by a computer network.

17. The system of claim 15 further including a second remote recipient, wherein the central control system transmits at least a portion of the at least one electronic document image to the second remote recipient.

18. The system of claim 17 wherein the second remote recipient and the central control system are operatively connected by a computer network.

19. The system of claim 17 wherein the at least a portion of the at least one electronic document image received by the first recipient is different from the at least a portion of the at least one electronic document image received by the second recipient.

20. The system of claim 1 further including a biometric data scanner operatively connected to the point of sale system.

21. The system of claim 20 wherein the biometric data scanner is one of a fingerprint scanner and an iris scanner.

22. The system of claim 1 further a peripheral device operatively connected to the point of sale system.

23. The system of claim 22 wherein the peripheral device is at least one of a Bluetooth transceiver, a radio frequency transceiver, an infrared transceiver, a USB port, or a digital media port.

24. The system of claim 22 wherein the peripheral device is bar code scanner.

25. The system of claim 1 wherein the point of sale system further including a display device.

26. The system of claim 1 wherein the point of sale system includes at least one of bar code or character recognition software, wherein the point of sale system extracts data from the at least one electronic document image.

27. The system of claim 26 wherein the point of sale system is operatively connected to transmit the extracted data to a remote recipient.

28. The system of claim 27 wherein the point of sale system is operatively connected to the remote recipient by a computer network.

29. The system of claim 27 wherein the point of sale system converts the extracted data into a standard interface protocol.

30. The system of claim 26 wherein the point of sale system is operatively connected to transmit the extracted data to a central control system.

31. The system of claim 30 wherein the point of sale system is operatively connected to the central control system by a computer network.

32. The system of claim 30 wherein the central control system transmits the extracted data to a remote recipient.

33. The system of claim 32 wherein the remote recipient is operatively connected to the central control system by a computer network.

34. A transportation document delivery system comprising:
a point of sale system located at a truck stop, the point of sale system including a point of sale device and a document scanner, the point of sale device operatively connected to receive electronic images of transportation documents from the scanner;
a central control system in communication with the point of sale system by a distributed computer network; and
a remote recipient operatively connected to receive at least a portion of the electronic images of transportation documents from one of the point of sale system and the central control system.

35. A method of delivering documents comprising the steps of:
providing a point of sale system at a truck stop; and
importing at least one electronic document image into the point of sale system.

36. The method of claim 35 wherein the electronic document image is of a transportation document.

37. The method of claim 36 wherein the transportation document is one of a proof of delivery, a bill of lading, a receipt, a logs sheet, a rate confirmation sheet or an employment document.

38. The method of claim 35 wherein the at least one electronic document image is imported from a scanner operatively connected to the point of sale system.

39. The method of claim 35 wherein the at least one electronic document image is imported from a digital camera.

40. The method of claim 35 further including the step of transmitting the at least one electronic document image to at least one recipient.

41. The method of claim 40 wherein the transmitting step occurs over a computer network.

42. The method of claim 40 wherein the transmitting step is performed by the point of sale system.

43. The method of claim 40 wherein the transmitting step is performed by a central control system operatively connected to the point of sale system.

44. The method of claim 40 further including the step of providing a loyalty point upon the completion of at least one of the importing step and the transmitting step.

45. The method of claim 40 wherein at least one recipient is determined based on data acquired by the point of sale system.

46. The method of claim 40 wherein the at least one recipient is determined by reading information contained on a barcode on the electronic document image.

47. The method of claim 40 wherein the at least one recipient is determined by reading information on one of a magnetic card, a smart card, a loyalty card or an electronic identification.

48. The method of claim 40 wherein the at least one recipient is determined based on the biometric information of a truck driver.

49. The method of claim 40 wherein the importing step is performed by an operator, wherein the at least one recipient is determined by the operator.

50. The method of claim 40 further including the step of providing an acknowledgement upon the completion of at least one of the importing step and the transmitting step.

51. The method of claim 50 further including the step of providing a unique identifier with the acknowledgement.

52. The method of claim 51 wherein the unique identifier is one of a number or a code word.

53. The method of claim 50 wherein the acknowledgement is a paper receipt.

54. The method of claim 50 wherein the acknowledgement is an electronic acknowledgement.

55. The method of claim 54 wherein the electronic acknowledgement is delivered to a computer.

56. The method of claim 54 wherein the electronic acknowledgement is delivered to one of a smart-card, loyalty card or a personal identification device enabled to receive input from the point of sale system.

57. The method of claim 54 wherein the electronic acknowledgement is delivered to one of a smart-card, loyalty card or a personal identification device enabled to receive input from a central control system operatively connected to the point of sale system.

58. The method of claim 54 wherein the electronic acknowledgement is delivered to an onboard/handheld tracking or messaging system.

59. The method of claim 54 wherein the electronic acknowledgement is delivered to a portable communications device.

60. The method of claim 54 wherein the electronic acknowledgement is delivered to a cellular phone.

61. The method of claim 54 wherein the electronic acknowledgement is delivered to one of a smart-phone, a personal digital assistant device and a handheld computer device.

62. The method of claim 35 further including the steps of:
transmitting at least a portion of the at least one electronic document image to a first recipient; and
transmitting at least a portion of the at least one electronic document image is to a second recipient.

63. The method of claim 62 wherein at least one of the transmitting to the first recipient step or the transmitting to the second recipient step is performed over a computer network.

64. The method of claim 62 wherein the at least one document image transmitted to the first recipient is at least partially different from the at least one document image transmitted to the second recipient.

65. The method of claim 35 further including the step of extracting data from the at least one imported electronic document image.

66. The method of claim 65 wherein the extracting step is performed by the point of sale system.

67. The method of claim 65 wherein the extracting step is performed by a central control system operatively connected to the point of sale system.

68. The method of claim 65 wherein the at least one document image is transmitted to at least one recipient based on the data extracted from the documents.

69. The method of claim 65 wherein the extracting step is performed using automated data extraction.

70. The method of claim 65 wherein the extracting step is performed using one of Optical Character Recognition (OCR), Intelligent Character Recognition (ICR), Optical Mark Recognition (OMR) and/or bar code reading.

71. The method of claim 65 further including the step of converting the extracted data into a standard interface protocol.

72. The method of claim 71 further including the step of transmitting the converted extracted data to at least one remote recipient.

73. The method of claim 71 wherein the standard interface protocol is one of ANSI EDI, XML and a CSV file.

74. The method of claim 35 further including the step of presenting the at least one electronic document image on a display.

75. The method of claim 74 further including the step of reviewing the presented image.

76. The method of claim 75 further including the step of electronically adjusting the document image.

77. The method of claim 76 wherein the step of adjusting documents electronically is performed by the use of at least one of a keyboard, a mouse or touch screen.

78. The method of claim 75 further including the steps of:
rejecting the image of the electronic document image on the display; and
repeating the step of importing at least one electronic document image into the point of sale system.

79. The method of claim 75 further including the steps of:
inputting additional data; and
associating the additional data with the electronic document image on the display.

80. The method of claim 79 wherein the inputting step is performed by the use of at least one of a keyboard, a mouse or touch screen.

81. The method of claim 35 further including the step of:
monitoring the status of the point of sale system; and
reporting the status to an operator of the point of sale system.

82. The method of claim 35 wherein the truck stop is one of: a truck stop, a travel center, a commercial vehicle fueling location, and a commercial vehicle service location.

83. The method of claim 35 further including the step of operating the point of sale system, wherein the operating step is performed by a truck stop employee, and wherein the importing step is performed by an authorized user independently of the operating step.
